(19) United States
(12) Patent Application Publication
(10) Pub. No.: US 2022/0063625 A1
(43) Pub. Date: Mar. 3, 2022

(54) VEHICLE CONTROL METHOD AND VEHICLE CONTROL DEVICE

(71) Applicant: Hitachi Astemo, Ltd., Hitachinaka-shi, Ibaraki (JP)

(72) Inventors: Koichiro OZAKI, Hitachinaka-shi (JP); Yusuke KOGURE, Hitachinaka-shi (JP); Yoshitaka FUKASAWA, Hitachinaka-shi (JP); Tomoyasu SAKAGUCHI, Hitachinaka-shi (JP)

(73) Assignee: Hitachi Astemo, Ltd., Hitachinaka-shi, Ibaraki (JP)

(21) Appl. No.: 17/423,240

(22) PCT Filed: Jan. 10, 2020
(86) PCT No.: PCT/JP2020/000572

§ 371 Date: Jul. 15, 2021

(30) Foreign Application Priority Data
Jan. 24, 2019 (JP) 2019-010631

(51) Int. Cl. B60W 30/18; B60W 10/04; B60W 10/184

(52) U.S. Cl. CPC B60W 30/18018; B60W 10/04; B60W 2552/15; B60W 2520/04; B60W 10/184

(57) ABSTRACT

A vehicle braking force proportional to a gradient is reduced to zero after the vehicle is stopped by the braking force, thereby reducing the time for applying a braking force. A system and method for vehicle control includes a processor and a memory. The vehicle control method including a first step of the processor generating a command for applying a first braking force preset to hold the vehicle in a stopped state, a second step of the processor acquiring, from a gradient detection device, a gradient of a road surface on which the vehicle is traveling after applying the first braking force, the gradient being detected by the gradient detection device, a third step of the processor computing a second braking force proportional to the gradient of the road surface, and a fourth step of the processor applying the second braking force to the braking device.

### TECHNICAL FIELD

The present invention relates to drive control of a vehicle.

### BACKGROUND ART

A known vehicle control device, vehicle control method, and vehicle control program allow control of a vehicle with high responsivity by releasing a braking force in response to an increase in speed of the vehicle when acceleration control or acceleration operation is performed (see, for example, PTL 1).

### CITATION LIST

### Patent Literature

PTL 1: JP 2018-070103 A

### SUMMARY OF INVENTION

### Technical Problem

The technique disclosed in PTL 1 is configured to continue increasing, in a scene where a vehicle stops and then starts, a braking force until a vehicle speed changes after the vehicle stops by application of the braking force, which may take time to reduce the braking force under certain start conditions and thus make responsivity lower.

The present invention has been made in view of the above-described problems, and it is therefore an object of the present invention to reduce, when a vehicle stops and then starts, a braking force proportional to a gradient to zero after the vehicle is stopped and held by the braking force, so as to shorten time taken for reducing the braking force to allow the vehicle to start with high responsivity.

### Solution to Problem

In order to achieve the above-described object, the present invention is configured as follows.

Provided according to the present invention is a vehicle control method for controlling a vehicle by a vehicle control device including a processor and a memory, the vehicle control method including a first step of causing the processor to give, to a braking device connected to the vehicle control device, a command for applying a first braking force preset to hold the vehicle in a stopped state, a second step of causing the processor to acquire, from a gradient detection device, a gradient of a road surface on which the vehicle is traveling after giving the command for applying the first braking force, the gradient being detected by the gradient detection device, a third step of causing the processor to compute a second braking force proportional to the gradient of the road surface, and a fourth step of causing the processor to give a command for applying the second braking force to the braking device.

### Advantageous Effects of Invention

According to the present invention, the second braking force proportional to the gradient is computed from a detection value of the gradient, the braking force is reduced from the first braking force to the second braking force proportional to the gradient, and then the braking force is reduced to zero, which makes time taken for reducing the braking force shorter and thus makes time taken for the start shorter.

Further, a driving force that causes the vehicle to start is set equal to or greater than a force due to the gradient that causes the vehicle to descend, thereby allowing control of the vehicle with high responsivity.

Details of at least one embodiment of the subject matter disclosed herein are set forth in the accompanying drawings and the following description. Other features, aspects, and effects of the disclosed subject matter will be apparent from the following disclosure, drawings, and claims.

### BRIEF DESCRIPTION OF DRAWINGS

FIG. 1 is a block diagram showing a structure of a vehicle control device to which the present invention is applied.

FIG. 2 is a functional block diagram of the vehicle control device to which the present invention is applied.

FIG. 3 is a timing chart showing changes in various states in response to a process executed by the vehicle control device.

FIG. 4 is a flowchart showing an example of the process executed by the vehicle control device.

FIG. 5 is a graph showing various states brought about by the process executed by the vehicle control device.

FIG. 6 is a graph showing various states brought about by the process executed by the vehicle control device.

FIG. 7 is a timing chart showing changes in various states in response to the process executed by the vehicle control device.

FIG. 8 is a timing chart showing changes in various states in response to the process executed by the vehicle control device.

### DESCRIPTION OF EMBODIMENTS

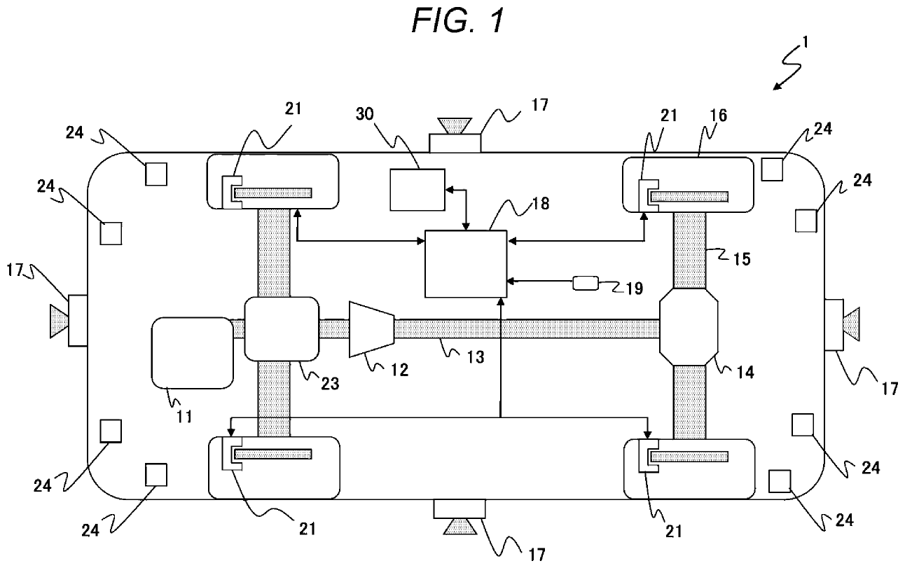

Hereinafter, a description will be given of an embodiment of the present invention with reference to the drawings. FIG. 1 is a block diagram showing a structure of a vehicle according to the present invention. A vehicle 1 shown as an example is a rear-wheel drive vehicle including, for example, a gasoline engine 11 of a direct injection type as a drive power source, an automatic transmission 12 capable of coming into contact with and separating from the engine 11, a propeller shaft 13, a differential gear 14, a drive shaft 15, a brake device 21 including four wheels 16 and a wheel speed sensor, and an electric power steering 23.

Devices including a vehicle control device 18 and various sensors 19 to be described later, actuators, and instruments are connected to the vehicle 1 so as to be able to transmit and receive signals or data over an in-vehicle LAN or CAN communication. The vehicle control device 18 receives information on the outside of its own vehicle from the sensors to be described later, and transmits a command value for enabling control such as automated parking or automated driving to the engine 11, the brake device 21 including the wheel speed sensor, the electric power steering 23, and the automatic transmission 12. The wheel speed sensor generates a pulse wave in response to rotation of the wheels and transmits the pulse wave to the vehicle control device 18.

Sensors such as a monocular camera 17 and sonar 24 are provided in the front, rear, and sides of the vehicle 1. Such sensors detect a state of an obstacle around the vehicle and a road condition and gives the result to the vehicle control device 18. Note that the left side of FIG. 1 corresponds to the front of the vehicle 1. Further, the vehicle 1 has a gradient sensor 30 provided as a gradient detection device that detects a gradient of a road surface.

Note that the vehicle 1 shown in FIG. 1 is an example of a vehicle to which the present invention is applicable, and the present invention is not intended to limit the structure of a vehicle to which the present invention is applicable. For example, the vehicle 1 may be a vehicle having a continuously variable transmission (CVT) provided instead of the automatic transmission 12. Alternatively, the vehicle 1 may be a vehicle having a motor provided as a drive power source instead of or together with the engine 11 serving as a drive power source.

Further, a sensor that detects a travel condition of the vehicle 1 or an obstacle is not limited to the above-described sensors and may include a radar or light detection and ranging (LiDAR).

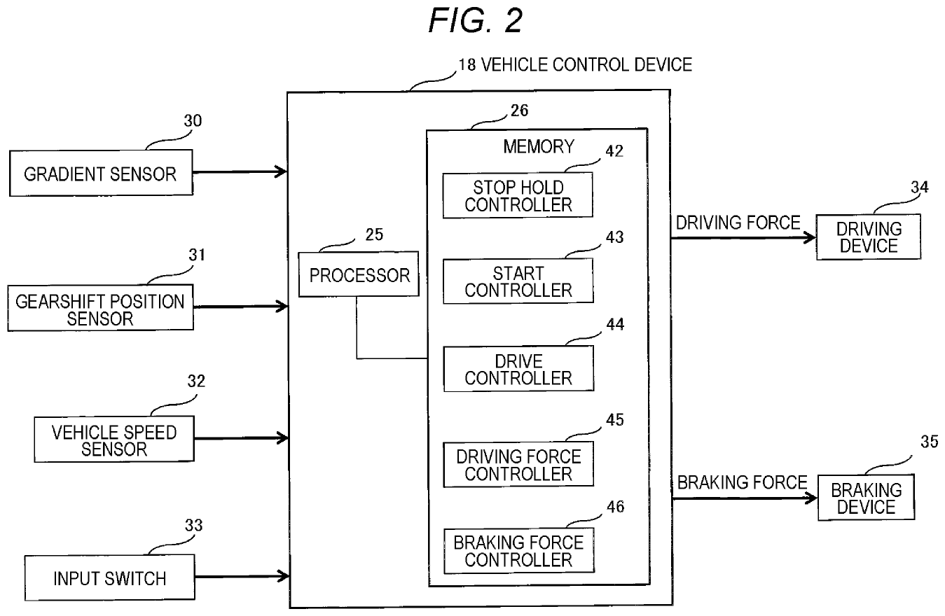

FIG. 2 is a functional block diagram of the vehicle control device 18 to which the present invention is applied. The vehicle control device 18 shown in FIG. 2 is mounted on the vehicle 1 and is connected to the gradient sensor 30, a gearshift position sensor 31, a vehicle speed sensor 32, an input switch 33, a driving device 34, and a braking device 35.

The vehicle control device 18 includes a processor 25 and a memory 26. Each of the functional modules including a stop hold controller (stop hold module) 42, a start controller 43, a drive controller 44, a driving force controller 45, and a braking force controller 46 is loaded into the memory 26 as a program and executed by the processor 25.

The processor 25 operates as each of the functional modules that provides a predetermined function by executing a corresponding process in accordance with the program of the functional module. For example, the processor 25 acts as the braking force controller 46 by executing a corresponding process in accordance with a braking force control program. The same applies to the other programs. Furthermore, the processor 25 also operates as a functional module that provides a function corresponding to each of a plurality of processes executed in accordance with each program. A computer and a computer system are a device and a system that include such functional modules.

The gradient sensor 30 detects a gradient of a road surface on which the vehicle 1 is traveling. The gradient may be obtained by any suitable approach. According to the present embodiment, an accelerometer that detects forward or backward acceleration of the vehicle 1 may be employed as the gradient sensor 30. The gradient sensor 30 estimates a slope of the road surface based on a detection value of the acceleration. The gradient sensor 30 is not limited to the above-described configuration, and the gradient sensor 30 may be a sensor provided on the vehicle 1 to detect the slope of the road surface (a pitch angle of the vehicle) and may obtain the gradient of the road surface from a detection value from the sensor. Further, the accelerometer serving as the gradient sensor 30 is not limited to a sensor that detects forward or backward acceleration, and a three-axis accelerometer may be used.

The gearshift position sensor 31 is a sensor that measures a gearshift position of the automatic transmission 12.

The vehicle speed sensor 32 includes a wheel speed sensor that is attached to each wheel 16 of the vehicle 1 and detects a rotation speed of the wheel 16, and a controller that generates a vehicle speed signal by compiling detection values detected by the wheel speed sensors. The vehicle speed sensor 32 detects a speed of the vehicle 1 and outputs a vehicle speed signal indicating the speed thus detected to the vehicle control device 18.

The input switch 33 is, for example, an application-specific mechanical switch provided around a driver's seat. Further, the input switch 33 may be a graphical user interface (GUI) switch or the like. The input switch 33 receives an instruction for automated control of the vehicle 1 in response to an operation made by the driver.

The stop hold controller 42 outputs, to the braking force controller 46, a command for holding the vehicle 1 in the stopped state.

Upon detection of a start operation of the vehicle 1 made by the driver while the vehicle 1 is held in the stopped state by the stop hold controller 42, the start controller 43 outputs, to the braking force controller 46, a command for releasing the braking force to terminate the state where the vehicle is held in the stopped state by the stop hold controller 42, and outputs, to the driving force controller 45, a command for generating the driving force to start the vehicle 1. In response to the command from the start controller 43, the braking force controller 46 gives, to the braking device 35, a command for releasing the braking force for holding the vehicle 1 in the stopped state.

The drive controller 44 controls the drive of the vehicle 1 after the start control by the start controller 43 is completed. The drive controller 44 may cause the vehicle 1 to cruise, accelerate, decelerate, or the like via the braking force controller 46 and the driving force controller 45.

The driving force controller 45 controls the driving device 34 that generates a driving force. The driving force controller 45 controls the driving device 34 to drive the vehicle in accordance with the command from the start controller 43. Here, the driving device 34 that generates the driving force may be a widely or publicly known device and may be made up of, for example, a throttle valve and an intake valve that control the flow rate of intake air flowing into the engine 11.

The driving force controller 45 may control the flow rate of intake air by adjusting a degree of opening of the throttle valve or by adjusting a lift amount or opening/closing timing of the intake valve.

Further, when the driving force controller 45 drives, like a hybrid vehicle, the vehicle 1 with not only the driving force generated by the engine 11 but also a driving force generated by a motor, the driving device 34 may be the motor. The driving force controller 45 may control the driving force by controlling the motor.

The braking force controller 46 controls the braking device 35 that generates a braking force. The braking force controller 46 controls the braking device so as to hold the vehicle 1 in the stopped state in accordance with the command from the stop hold controller 42. Herein, an example where the above-described brake device 21 is employed as the braking device 35 that generates the braking force will be described, but the present invention is not limited to such an example. The braking device 35 may have a widely or publicly known structure, and may be made up of, for example, a hydraulic brake device and an electronic parking brake.

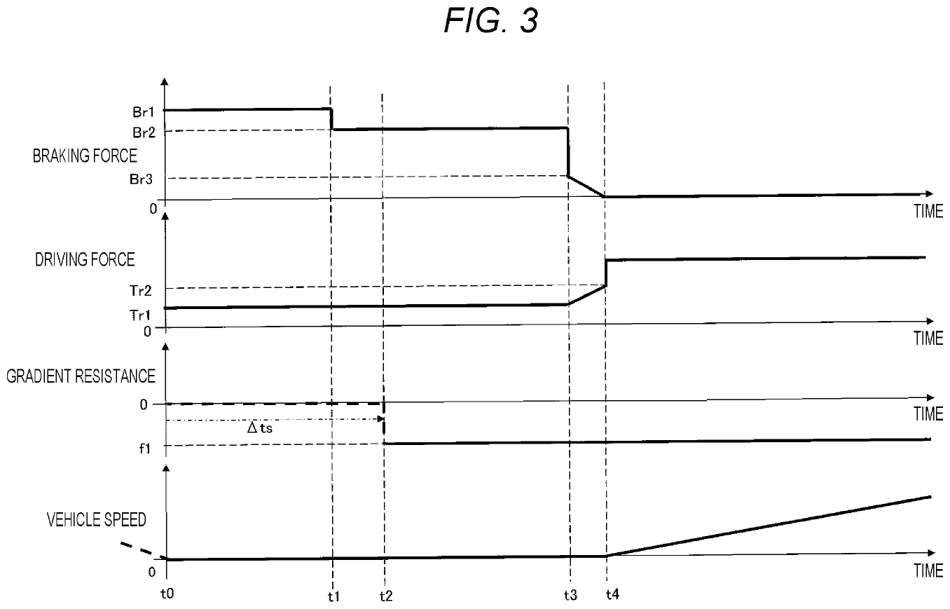

FIG. 3 is a timing chart showing changes in various states in response to a process executed by the vehicle control device 18. According to the present embodiment, it is assumed that the vehicle 1 is at a stop on a road surface having a predetermined gradient and starts in the forward direction of the vehicle 1 in the state where the vehicle 1 is at a stop. It is further assumed that the predetermined gradient is so steep that the vehicle 1 cannot be held in the stopped state only by a predetermined creep driving force acting on the vehicle 1. Note that the creep driving force corresponds to a driving force generated while the engine 11 is idling.

The vertical axis of the timing chart in FIG. 3 indicates, in order from the top, changes over time in braking force generated by the vehicle 1, driving force output by the vehicle 1, gradient resistance of the road surface, and vehicle speed. The horizontal axis in FIG. 3 indicates time. The gradient resistance indicates a force (descending force) acting on the vehicle 1 due to the road surface gradient and gravity, a dashed line in FIG. 3 indicates a state where a read value of the gradient sensor 30 is unusable, and a solid line indicates a state where the read value of the gradient sensor 30 is usable.

Further, in the example shown in FIG. 3, the driver operates the brake device 21 to hold the vehicle 1 in the stopped state until time t1, and the driver operates the input switch 33 to request the activation of vehicle control at time t1. Then, at time t3, a start request is made, and the vehicle control device 18 activates start control to gradually reduce the braking force and gradually increase the driving force. Then, at time t4, the driving force causes the vehicle 1 to start.

In a period from time t0 to time t1, the vehicle 1 is held in the stopped state by a braking force Br1 generated by the operation of the braking device 35 (brake device 21) made by the driver. In the period from time t0 to time t1, the driving force generated by the vehicle 1 is maintained at a low predetermined value, for example, a creep driving force Tr1. Further, a driving force Tr2 in FIG. 3 indicates a driving force value necessary to keep the driving force and the gradient of the road surface in balance.

That is, in order to hold the vehicle 1 in the stopped state on a road surface having a gradient, it is necessary to apply, to the vehicle 1, a force (driving force or braking force) that cancels out a force (gradient resistance) acting on the vehicle 1 due to the gradient. The driving force Tr2 indicates the magnitude of the driving force necessary to hold the vehicle 1 in the stopped state on the road surface having the gradient when no braking force is applied to the vehicle 1.

At time t1, the driver operates the input switch 33 to enable the vehicle control, thereby activating the control by the vehicle control device 18. The vehicle 1 is held in the stopped state under the control, and when the driver releases the braking device 35, the braking force reduces from the braking force Br1 generated by the manual operation made by the driver to a predetermined braking force Br2. The predetermined braking force Br2 is, for example, a preset maximum braking force.

At time t2, the vehicle control device 18 acquires the value of the gradient sensor 30 with the vehicle held in the stopped state. A description will be given of an example according to the present embodiment where an accelerometer is employed as a means for acquiring a gradient. The accelerometer is capable of acquiring, with high accuracy, the road surface gradient by detecting that an amount of change in acceleration becomes equal to or less than a predetermined value when a predetermined period of time elapses after the vehicle is stopped. Further, the vehicle control device 18 computes gradient resistance f1 from the road surface gradient thus acquired. A well-known method may be used to compute the gradient resistance f1.

Note that when the accelerometer is employed as the gradient sensor 30, the vehicle control device 18 prohibits the detection of the gradient over a predetermined period of time Δts (time t2) from time t0 when the vehicle 1 is stopped. Immediately after the vehicle 1 is stopped, the output of the accelerometer contains changes (fluctuations). For this reason, over the predetermined period of time Δts, the detection of the gradient is prohibited to prevent fluctuating acceleration from being used. Then, the vehicle control device 18 acquires the detection value from the gradient sensor 30 after the elapse of the predetermined period of time Δts, thereby allowing to an increase in measurement accuracy of the gradient.

In a period from time t2 to time t3, the vehicle control device 18 computes, from the gradient resistance f1 thus computed, a braking force Br3 proportional to the gradient resistance f1 in order to hold the vehicle 1 in the stopped state.

Here, the braking force Br3 proportional to the gradient resistance f1 may be computed from the gradient resistance f1 and the creep driving force Tr1, and details of the process will be described later.

At time t3, upon receipt of the start request, the vehicle control device 18 activates the start control to control the braking force. Note that the start request is a command from the driver, a driving operation (stepping on an accelerator pedal), a command from the start controller 43, or the like.

The vehicle control device 18 reduces the braking force from the predetermined braking force Br2 to the braking force Br3 proportional to the gradient (gradient resistance f1). In this case, the sum of the braking force Br3 proportional to the gradient and the creep driving force Tr1 is in balance with the gradient resistance f1, thereby allowing the vehicle 1 to be held in the stopped state without descending even when the braking force is reduced.

In a period from time t3 to time t4, the vehicle control device 18 gradually reduces the braking force from the braking force Br3 proportional to the gradient to zero. Further, the vehicle control device 18 gradually increases the driving force from the creep driving force Tr1 to the driving force Tr2 that is in balance with the gradient. The vehicle control device 18 performs control to make the sum of the braking force and the driving force equal to the gradient resistance f1, thereby allowing the vehicle 1 to be held in the stopped state without descending.

At time t4, when the braking force is completely released (becomes zero), the vehicle control device 18 can increase the vehicle speed by making the driving force greater than the driving force Tr2 that is in balance with the gradient resistance f1, thereby allowing the vehicle 1 to start smoothly.

Note that, in FIG. 3, the vehicle 1 is held in the stopped state by the operation made by the driver in the period from time t0 to t1. Further, the state where vehicle 1 is held in the stopped state in a period from time t1 to time t3 is made possible by the stop hold controller 42, the start control in the period from time t3 to time t4 is made possible by the start controller 43, and the drive state after time t4 is made possible by the drive controller 44.

As described above, the vehicle control device 18 detects the gradient while the vehicle 1 is at a stop after holding the vehicle 1 in the stopped state by the braking force Br2, reduces the braking force to the braking force Br3 proportional to the gradient, and then starts the vehicle 1, which makes the time taken for reducing the braking force shorter and thus makes the time taken for the start shorter.

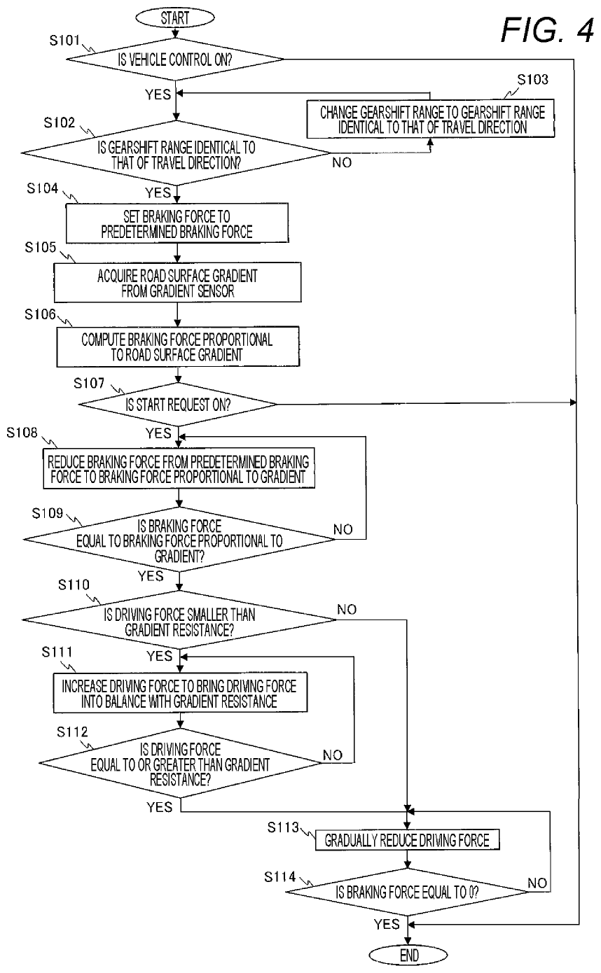

FIG. 4 is a detailed flowchart of a process of the start control according to the embodiment of the present invention.

Note that, in the following description, the vehicle control device 18 plays a primary role in the process, but the processor 25 or the program may be regarded as an entity that plays a primary role in the process. Further, this process is repeatedly executed at predetermined intervals.

In step S101, the vehicle control device 18 determines whether the activation of the vehicle control requested by the driver is detected. As described above, the vehicle control device 18 may make this determination by detecting whether the predetermined input switch 33 is operated. The vehicle control device 18 proceeds to step S102 when the vehicle control (ON) is detected, and terminates the process when the vehicle control operation (ON) is not detected.

When the vehicle control (ON) is detected, the vehicle control device 18 acquires a detection signal of the gearshift position sensor 31 in step S102, and determines whether a gearshift position indicated by the detection signal is identical in direction to a travel direction of the vehicle control.

Note that the gearshift position indicates a gear range selectable by a gearshift (not shown) or a gear switch (not shown), such as a drive (D) range, a reverse (R) range, or the like.

When the gearshift position is identical in direction to the travel direction of the vehicle 1 under the control of the vehicle control device 18, the process proceeds to step S104. When the gearshift position is different in direction from the travel direction under the control of the vehicle control device 18, the vehicle control device 18 changes the gearshift position to make the gearshift position identical in direction to the travel direction of the control in step S103.

In step S104, the vehicle control device 18 sets the braking force to the predetermined braking force (Br2) and controls the braking device 35.

Next, in step S105, the vehicle control device 18 acquires the gradient of the road surface on which the vehicle is at a stop based on, for example, the detection signal of the gradient sensor 30 and computes the gradient resistance f1 from the value thus acquired as described above.

In step S106, the vehicle control device 18 computes the braking force (Br3) proportional to the gradient from the gradient resistance f1 computed in step S105. The process of computing the braking force proportional to the gradient will be described later in detail.

In step S107, the vehicle control device 18 determines whether the start request is detected. Note that the vehicle control device 18 activates the start control when the start request is received, and a predetermined condition is satisfied. The predetermined condition is, for example, a condition where the road surface gradient has been read from the gradient sensor 30, and the driving device (the driving device 34 and the braking device 35) is controllable. Note that even when having received the start request, the vehicle control device 18 waits until the predetermined condition is satisfied.

The vehicle control device 18 detects the start request and proceeds to step S108 when the predetermined condition is satisfied. When the start request is not detected, the process is terminated.

In step S108, the vehicle control device 18 outputs, to the braking force controller 46, a command for reducing the braking force from the predetermined braking force (Br2) to the braking force (Br3) proportional to the gradient.

In step S109, the braking force controller 46 of the vehicle control device 18 determines whether the braking force becomes equal to the braking force (Br3) proportional to the gradient. When the braking force has yet to be reduced to the braking force (Br3) proportional to the gradient, the process returns to step S108 to continue the control of the braking force. On the other hand, when the braking force has been reduced to the braking force (Br3) proportional to the gradient, the process proceeds to step S110.

In step S110, the driving force controller 45 of the vehicle control device 18 determines whether the driving force is smaller than the gradient resistance f1. When the driving force is smaller than the gradient resistance f1, the vehicle control device 18 proceeds to step S111. On the other hand, when the driving force is equal to the gradient resistance f1, the vehicle control device 18 maintains the current driving force.

In step S111, the vehicle control device 18 outputs, to the driving force controller 45, a command for bringing the driving force into balance with the gradient resistance f1. In step S112, a determination is made as to whether the driving force has been brought into balance with the gradient resistance f1. When the driving force has yet to be brought into balance with the gradient resistance f1, the vehicle control device 18 returns to step S111 and continues the driving force control. On the other hand, when the driving force has been brought into balance with the gradient resistance f1, the vehicle control device 18 maintains the driving force and proceeds to step 113.

In step S113, the vehicle control device 18 outputs, to the braking force controller 46, a command for releasing the braking force. It is preferable to control the braking force as quick as possible. Such control allows the vehicle 1 to start more quickly.

In step S114, the vehicle control device 18 determines whether the braking force becomes zero. When the braking force is not zero, the vehicle control device 18 returns to step S113 and continues the braking force control. On the other hand, the braking force that becomes zero indicates that the start control is completed. Subsequently, the vehicle control device 18 causes the drive controller to gradually increase the vehicle speed by increasing the driving force from the driving force that is in balance with the gradient resistance f1, thereby allowing the vehicle 1 to start smoothly.

As described above, upon receipt of the start request, the vehicle control device 18 outputs, to the braking device 35 and the driving device 34, the command for reducing the braking force to the braking force Br3 proportional to the gradient resistance f1 and then increasing the driving force to the driving force Tr2 proportional to the gradient resistance f1. Then, the vehicle control device 18 outputs a command for making the braking force equal to zero after increasing the driving force to the driving force Tr2 proportional to the gradient, thereby allowing quick and smooth start.

Further, after bringing the vehicle 1 to a stop with the braking force Br2, the vehicle control device 18 outputs, upon receipt of the start request, the command for reducing the braking force to the braking force Br3 proportional to the gradient to the braking device 35, thereby allowing the vehicle 1 to be securely held in the stopped state.

Further, the gradient sensor 30 detects the gradient when the predetermined period of time (Δts) elapses after the vehicle is stopped, thereby allowing the vehicle control device 18 to acquire an accurate detection value without fluctuations that occur immediately after the vehicle is stopped.

Further, upon receipt of the start request, the vehicle control device 18 gives, to the braking device 35, the command for making the braking force equal to the braking force Br3 proportional to the gradient and then reducing the braking force that becomes equal to the braking force Br3 to zero, thereby allowing smooth start.

Further, upon receipt of the start request, the vehicle control device 18 gradually increases the driving force by increasing the driving force from the creep driving force Tr1 to the driving force Tr2 proportional to the gradient, thereby allowing smooth start.

Further, the driving force Tr1 is the creep driving force Tr1, and the driving force Tr2 proportional to the gradient is a driving force that is in balance with the gradient resistance f1, thereby allowing the vehicle control device 18 to smoothly switch the driving force.

Further, the vehicle control device 18 outputs the command for increasing the driving force to the driving force Tr2 proportional to the gradient and then reducing the braking force, which makes the time taken for reducing the braking force shorter and thus allows quick start.

Further, the vehicle control device 18 computes the braking force Br3 proportional to the gradient based on the gradient resistance f1 and the driving force, thereby allowing smooth start without shock.

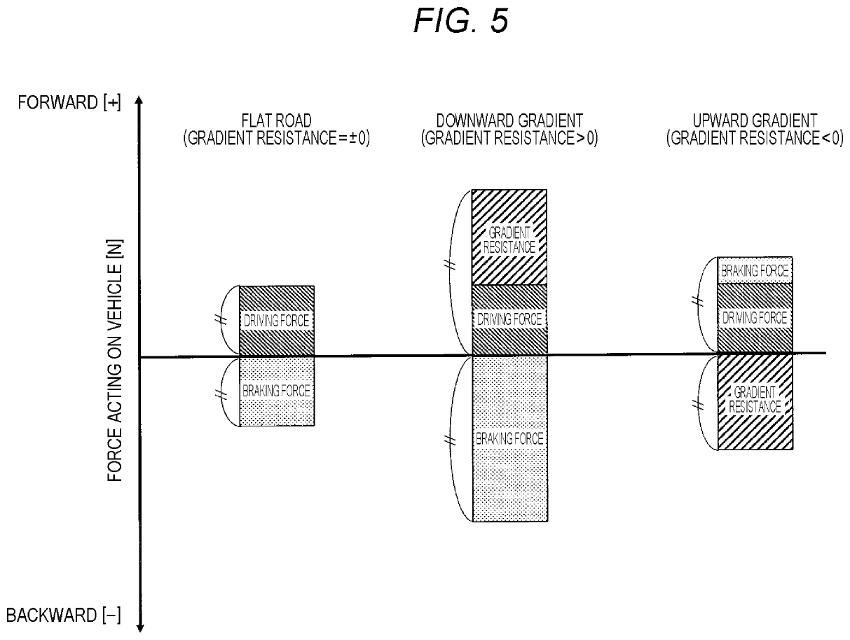

Next, a description will be given of a process of computing the braking force proportional to the gradient resistance f1 in step S106 with reference to FIG. 5.

FIG. 5 is a graph showing a relationship among the driving force and the braking force applied to the vehicle 1, and the gradient resistance when the travel direction of the vehicle is the forward direction. The example shown in FIG. 5 shows cases based on a flat road (gradient resistance is zero), a downward gradient (gradient resistance is positive), and an upward gradient (gradient resistance is negative) where the gradient resistance is greater than the creep driving force.

Here, the driving force corresponds to the creep driving force, the braking force corresponds to the braking force proportional to the gradient, and the gradient resistance corresponds to the gradient resistance (with no sensor error) computed from the detection value of the gradient sensor 30. Further, regarding the force acting on the vehicle 1 due to the gradient, it is assumed that the force acting in the forward direction of the vehicle 1 is positive, and the force acting in the backward direction of the vehicle 1 is negative. Note that the braking force acts as a reaction force.

Since the flat road has gradient resistance of zero, the force acting on the vehicle only includes the creep driving force acting in the forward direction. This allows the braking force proportional to the gradient to be computed as a value equal to the creep driving force.

Since the downward gradient has positive gradient resistance, the force acting on the vehicle 1 includes the creep driving force acting in the forward direction and the gradient resistance acting in the forward direction. This allows the minimum braking force required to hold the vehicle in a stopped state to be computed as a value equal to the sum of the creep driving force and the gradient resistance.

Since the upward gradient has negative gradient resistance, the force acting on the vehicle 1 includes the creep driving force acting in the forward direction and the gradient resistance acting in the backward direction. This allows the minimum braking force required to hold the vehicle in a stopped state to be computed as a value equal to a difference between the creep driving force and the gradient resistance.

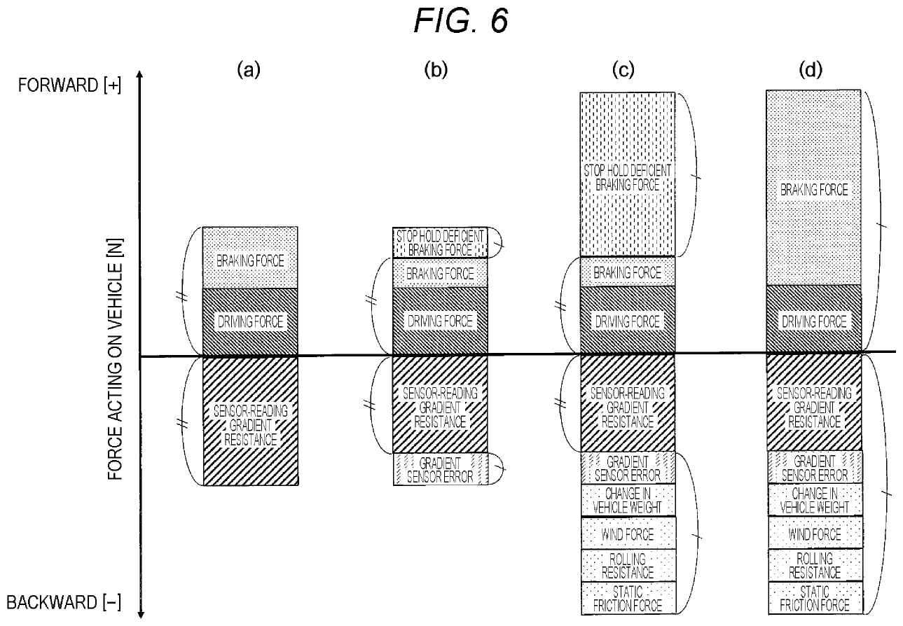

The computation method described above is applied to only a case where no consideration is given to variations in errors in the driving force, the braking force, and the gradient resistance generated by various sensors or various devices, ambient disturbance, and the like. Therefore, the braking force proportional to the gradient and the driving force that is in balance with the gradient according to the present embodiment correspond to a braking force and a driving force with consideration given to variations in errors generated by various sensors such as the read value of the gradient sensor 30, static friction force generated between a tire and a road surface, rolling resistance due to deformation of the tire, a weight of a load loaded on the own vehicle, air resistance due to a wind force, and the like. Then, the braking force proportional to the gradient and the driving force that is in balance with the gradient are output values that allow the vehicle to be held in the stopped state even when the maximum error occurs due to the disturbance described above. A description will be given of an example of such a case with reference to FIG. 6.

FIG. 6 is a graph showing a relationship among forces acting on the vehicle when the travel direction of the vehicle is the forward direction as in FIG. 5. Further, FIG. 6 only shows cases based on the upward gradient (gradient resistance is negative), and it is assumed that the gradient resistance is greater than the creep driving force. Here, it is assumed that the gradient resistance computed from the detection value of the gradient sensor 30 is referred to as sensor-reading gradient resistance, a difference between the sensor-reading gradient resistance and actual gradient resistance is referred to as a gradient sensor error, and a braking force equal to a deficient amount of the braking force proportional to the gradient that is not enough to hold the vehicle in a stopped state is referred to as a stop hold deficient braking force.

As described above, the relationship among the driving force, the braking force, and the gradient resistance with neither various errors nor disturbance taken into consideration is shown in (a) of FIG. 6. Here, the sum of the braking force and the driving force is equal to the sensor-reading gradient resistance.

(b) of FIG. 6 shows a case where the sensor-reading gradient resistance is smaller than the actual gradient. In the above-described case, since the sensor-reading gradient resistance is smaller than the actual gradient, the braking force proportional to the gradient brings about the stop hold deficient braking force and thus cannot hold the vehicle in the stopped state, causing the vehicle to descend.

Here, the stop hold deficient braking force is equal to the gradient sensor error.

(c) of FIG. 6 shows a case based on the case (b) where disturbance additionally occurs around the vehicle 1 due to the surrounding environment or the like. In the above-described case, since the stop hold deficient braking force is brought about due to a gradient sensor error, a change in vehicle weight, and changes in wind force, rolling resistance, static friction force, and the like, the vehicle 1 cannot be held in the stopped state and descends accordingly. Here, the stop hold deficient braking force is equal to the sum of the gradient sensor error, the change in vehicle weight, the wind force, the rolling resistance, and the static friction force.

Therefore, as shown in (d) of FIG. 6, in order to prevent the vehicle 1 from descending even when various sensor errors, disturbance errors, and the like occur, the braking force proportional to the gradient is set to a braking force that prevents the vehicle 1 from descending even when a force acting on the vehicle is generated due to the various errors described above. Here, the braking force corresponds to a value that allows the vehicle 1 to be held in the stopped state even when the various errors described above are the maximum, and the sum of the braking force and the driving force is a force equal to or greater than the sum of the sensor-reading gradient resistance, the gradient sensor error, the change in vehicle weight, the wind force, the rolling resistance, and the static friction force.

According to the embodiment of the present invention described above, gradually reducing the braking force after reducing the braking force from the predetermined braking force to the braking force proportional to the gradient makes the time taken for reducing the braking force shorter and thus makes the time taken for the start shorter.

Although the preferred embodiment of the present invention has been described, the present invention is not limited to the above-described embodiment at all, and various modifications may be made without departing from the gist of the present invention.

Further, the timing at which the braking force is reduced in steps S108 and S109 and the timing at which the driving force is increased in steps S110 to S112 shown in FIG. 3 are not limited to the timing after the start request, and may be any timing as long as the timing is between time t2 by which the road surface gradient is acquired and time t3 at which the start request is received.

Further, even when the braking force is zero, but the vehicle 1 is held in the stopped state with the gradient resistance and the driving force in balance with each other, the vehicle control device 18 turns on, in response to the start request, a brake light (not shown) to clearly indicate that the vehicle 1 is held in the stopped state.

Further, when the descending of the vehicle 1 is detected through fluctuations of the wheel speed pulse with the vehicle 1 held in the stopped state by the braking force reduced in proportion to the gradient, the vehicle control device 18 increases the braking force to a predetermined braking force (for example, Br2).

Further, an example where the vehicle control device 18 gradually reduces the braking force at a predetermined change rate (or change amount) in the period from time t3 to time t4 shown in FIG. 3 has been described, but the present invention is not limited to such an example. The change rate at which the braking force is reduced from the braking force (Br3) proportional to the gradient to zero (released) need not be continuous, and the same effect as described above can be obtained even when the braking force is reduced step by step in at least two stages.

Further, in the period from time t3 to time t4 shown in FIG. 3, the vehicle control device 18 gradually increases the driving force at a predetermined change rate (or change amount). Continuously increasing the driving force makes it possible to suppress shock (rapid change in acceleration) at the start and improve drivability.

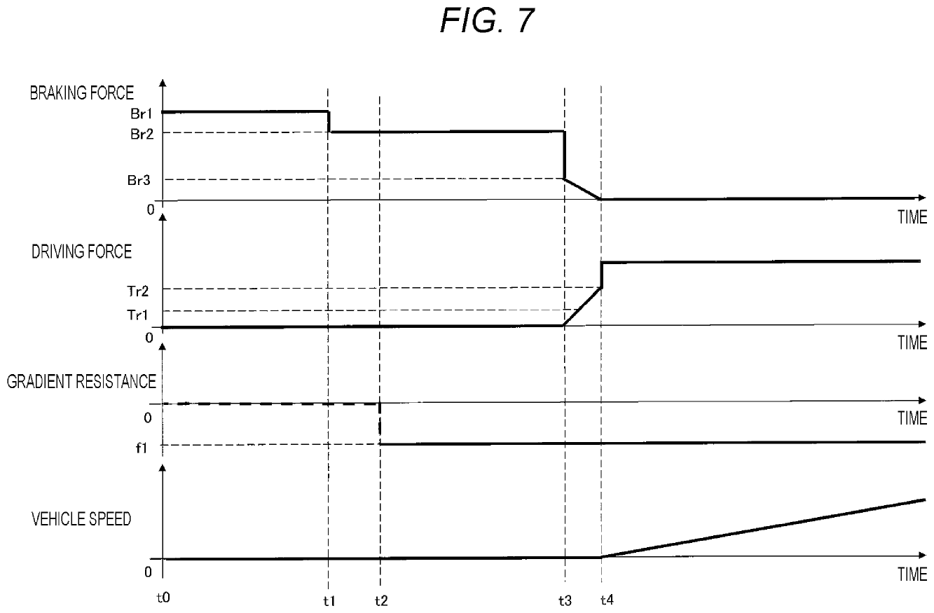

FIG. 7 is a timing chart of the vehicle control device 18 having idle reduction control. According to the above-described embodiment, a case where the engine 11 is kept idling, and the creep driving force continually acts with the vehicle held in the stopped state has been described, but the driving force becomes zero in an idle reduction state. This causes the braking force Br3 proportional to the gradient to be in balance with the gradient resistance f1.

Further, according to the present embodiment, the start control in a case where the gradient is so steep that the vehicle cannot be held in the stopped state only by the creep force has been described, but the present invention is applicable to various cases such as no gradient, an upward gradient, and a downward gradient under various conditions. In such cases, the braking device 35 is controlled so as to make the braking force closer to the braking force proportional to the gradient in accordance with the gradient conditions.

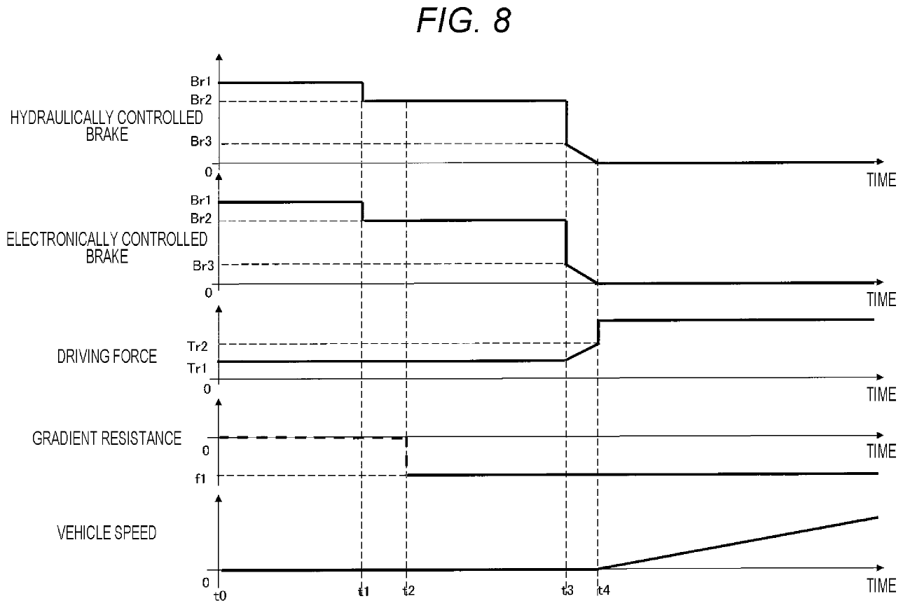

Further, the braking device 35 described according to the present embodiment may be, for example, a hydraulically controlled brake using a brake fluid, an electronically controlled brake that directly applies hydraulic pressure to a brake master cylinder using a motor, or the like. FIG. 8 is a timing chart of a modification of the present embodiment in which the braking force shown in FIG. 3 is changed to a hydraulically controlled brake and an electronically controlled brake. Even when the above-described various brake devices are used, the timing chart of the braking force is not changed.

This case is also similar to the above-described embodiment, and when the braking force is completely released (becomes zero) at time t4, the vehicle control device 18 can increase the vehicle speed by making the driving force greater than the driving force Tr2 that is in balance with the gradient resistance f1, thereby allowing the vehicle 1 to start smoothly.

Note that according to the above-described embodiment, an example where the accelerometer is employed as the gradient sensor 30 has been described, but the present invention is not limited to such an example. Examples of the device that detects the gradient may include a gyroscope and a global positioning system (GPS).

### Summary

As described above, the vehicle control device 18 according to the above-described embodiment may have the following structure.

(1) Provided is a vehicle control method for controlling a vehicle (1) by a vehicle control device (18) including a processor (25) and a memory (26), the vehicle control method including a first step (S104) of causing the processor (25) to give, to a braking device connected to the vehicle control device (18), a command for applying a first braking force (Br2) preset to hold the vehicle in a stopped state, a second step (S105) of causing the processor to acquire, from a gradient detection device (gradient sensor 30), a gradient of a road surface on which the vehicle is traveling after giving the command for applying the first braking force (Br2), the gradient being detected by the gradient detection device, a third step (S106) of causing the processor to compute a second braking force (Br3) proportional to the gradient of the road surface, and a fourth step (S108) of causing the processor to give a command for applying the second braking force (Br3) to the braking device (35).

As described above, the vehicle control device 18 detects the gradient while the vehicle 1 is at a stop after holding the vehicle 1 in the stopped state by the braking force Br2, reduces the braking force to the braking force Br3 proportional to the gradient, and then starts the vehicle 1, which makes the time taken for reducing the braking force shorter and thus makes the time taken for the start shorter.

(2) In the vehicle control method according to the above-described (1), the first braking force (Br2) is set as a maximum braking force for holding the vehicle in a stopped state, and in the fourth step, upon receipt of a start request, the command for applying the second braking force (Br3) is given to the braking device (35) to reduce a braking force.

As described above, after bringing the vehicle 1 to a stop with the braking force Br2, the vehicle control device 18 outputs, upon receipt of the start request, the command for reducing the braking force to the braking force Br3 proportional to the gradient to the braking device 35, thereby allowing the vehicle 1 to be securely held in the stopped state.

(3) In the vehicle control method according to the above-described (2), in the second step, the gradient is acquired when a predetermined period of time (Δts) elapses after the vehicle is stopped.

As described above, the gradient sensor 30 detects the gradient when the predetermined period of time (Δts) elapses after the vehicle is stopped, thereby allowing the vehicle control device 18 to acquire an accurate detection value without fluctuations that occur immediately after the vehicle is stopped.
(4) The vehicle control method according to the above-described (2) further includes a fifth step (S109) of causing the processor to determine whether the braking force applied by the braking device (35) has reached the second braking force (Br3), and a sixth step (S113) of causing the processor to output, when the braking force applied by the braking device (35) has reached the second braking force (Br3), a command for making the braking force equal to zero to the braking device (35).

As described above, upon receipt of the start request, the vehicle control device 18 gives, to the braking device 35, the command for making the braking force equal to the braking force Br3 proportional to the gradient and then reducing the braking force that becomes equal to the braking force Br3 to zero, thereby allowing smooth start.

(5) In the vehicle control method according to the above-described (2), the first step includes a step (S106) of giving, to a driving device (34) connected to the vehicle control device (18), a command for applying a first driving force (Tr1) which is preset, the third step includes a step (S106) of computing a second driving force (Tr2) which is equal to or greater than the first driving force (Tr1) and is proportional to the gradient of the road surface, and in the fourth step, upon receipt of the start request, a command for applying the second driving force (Tr2) is given to the driving device (34).

As described above, upon receipt of the start request, the vehicle control device 18 gradually increases the driving force by increasing the driving force from the creep driving force Tr1 to the driving force Tr2 proportional to the gradient, thereby allowing smooth start.

(6) In the vehicle control method according to the above-described (5), in the fourth step, upon receipt of the start request, a command for increasing a driving force from the first driving force (Tr1) to the second driving force (Tr2) is given to the driving device (34) to increase the driving force.

As described above, the vehicle control device 18 gradually increases the driving force by increasing the driving force from the creep driving force Tr1 to the driving force Tr2 proportional to the gradient, thereby allowing smooth start.

(7) In the vehicle control method according to the above-described (6), the first driving force (Tr1) is a predetermined driving force generated when the vehicle is held in the stopped state, and the second driving force (Tr2) is a driving force that is in balance with gradient resistance (f1) proportional to the gradient.

As described above, the driving force Tr1 is the creep driving force Tr1, and the driving force Tr2 proportional to the gradient is a driving force that is in balance with the gradient resistance f1, thereby allowing the vehicle control device 18 to smoothly switch the driving force.

(8) In the vehicle control method according to the above-described (5), in the fourth step, after the driving force has reached the second driving force (Tr2), a command for reducing the braking force is output to the braking device (35).

Further, the vehicle control device 18 outputs the command for increasing the driving force to the driving force Tr2 proportional to the gradient and then reducing the braking force, which makes the time taken for reducing the braking force shorter and thus allows quick start.

(9) In the vehicle control method according to the above-described (2), in the third step, gradient resistance (f1) proportional to the gradient is computed, and the second braking force (Br3) is computed based on a driving force which a driving device (34) connected to the vehicle control device (18) is commanded to apply and the gradient resistance (f1).

Further, the vehicle control device 18 computes the braking force Br3 proportional to the gradient based on the gradient resistance f1 and the driving force, thereby allowing smooth start without shock.

Note that the present invention is not limited to the above-described embodiment, and various modifications fall within the scope of the present invention.

For example, the description of the above-described embodiment has been given in detail in order to facilitate the understanding of the present invention, and the present invention is not necessarily limited to an embodiment having all the components described above. Further, some of the components of one embodiment may be replaced with components of another embodiment, and a component of another embodiment may be added to the components of one embodiment. Further, other components may be added to the components of each embodiment, some of the components of each embodiment may be removed, some of the components of each embodiment may be replaced with other components, or such addition, removal, and replacement may be made in combination.

Further, some or all of the components, functions, processing units, processing means, and the like described above may be implemented by hardware such as an integrated circuit designed to implement some or all of the components, functions, processing units, processing means, and the like. Further, each of the components, functions, and the like described above may be implemented by software that causes the processor to interpret and execute a program that makes each function work. Information such as a program, a table, and a file for making each function work may be stored in a storage device such as a memory, a hard disk, or a solid state drive (SSD), or in a recording medium such as an IC card, an SD card, or a DVD.

Further, control lines and information lines considered necessary for the description are only shown, and all the control lines and information lines necessary for the product are not necessarily shown. In practice, it may be considered that almost all the components are mutually connected.

### REFERENCE SIGNS LIST

1 vehicle
11 engine
12 automatic transmission
13 propeller shaft
14 differential gear
15 drive shaft
16 wheel
17 monocular camera
18 vehicle control device
24 sonar
21 brake device
23 electric power steering
25 processor
26 memory
30 gradient sensor
31 gearshift position sensor
32 vehicle speed sensor
33 input switch
34 driving device
35 braking device
41 vehicle control device
42 stop hold controller
43 start controller
44 drive controller
45 driving force controller
46 braking force controller

1. A vehicle control method for controlling a vehicle by a vehicle control device including a processor and a memory, the vehicle control method comprising:
a first step of causing the processor to give, to a braking device connected to the vehicle control device, a command for applying a first braking force preset to hold the vehicle in a stopped state;
a second step of causing the processor to acquire, from a gradient detection device, a gradient of a road surface on which the vehicle is traveling after giving the command for applying the first braking force, the gradient being detected by the gradient detection device;
a third step of causing the processor to compute a second braking force proportional to the gradient of the road surface; and
a fourth step of causing the processor to give a command for applying the second braking force to the braking device.

2. The vehicle control method according to claim 1, wherein
the first braking force is set as a maximum braking force for holding the vehicle in a stopped state, and
in the fourth step, upon receipt of a start request, the command for applying the second braking force is given to the braking device to reduce a braking force.

3. The vehicle control method according to claim 2, wherein
in the second step, the gradient is acquired when a predetermined period of time elapses after the vehicle is stopped.

4. The vehicle control method according to claim 2, further comprising:
a fifth step of causing the processor to determine whether the braking force applied by the braking device has reached the second braking force; and
a sixth step of causing the processor to output, when the braking force applied by the braking device has reached the second braking force, a command for making the braking force equal to zero to the braking device.

5. The vehicle control method according to claim 2, wherein
the first step includes a step of giving, to a driving device connected to the vehicle control device, a command for applying a first driving force which is preset,
the third step includes a step of computing a second driving force which is equal to or greater than the first driving force and is proportional to the gradient of the road surface, and
in the fourth step, upon receipt of the start request, a command for applying the second driving force is given to the driving device.

6. The vehicle control method according to claim 5, wherein
in the fourth step, upon receipt of the start request, a command for increasing a driving force from the first driving force to the second driving force is given to the driving device to increase the driving force.

7. The vehicle control method according to claim 6, wherein
the first driving force is a predetermined driving force generated when the vehicle is held in the stopped state, and
the second driving force is a driving force that is in balance with gradient resistance proportional to the gradient.

8. The vehicle control method according to claim 6, wherein
in the fourth step, after the driving force has reached the second driving force, a command for reducing the braking force is output to the braking device.

9. The vehicle control method according to claim 2, wherein
in the third step, gradient resistance proportional to the gradient is computed, and the second braking force is computed based on a driving force which a driving device connected to the vehicle control device is commanded to apply and the gradient resistance.

10. A vehicle control device which includes a processor and a memory and controls a vehicle, the vehicle control device comprising:
a stop hold module which gives, to a braking device connected to the vehicle control device, a command for applying a first braking force preset to hold the vehicle in a stopped state; and
a start controller which acquires, from a gradient detection device, a gradient of a road surface on which the vehicle is traveling after the command for applying the first braking force is given, the gradient being detected by the gradient detection device, computes a second braking force proportional to the gradient of the road surface, and gives a command for applying the second braking force to the braking device.

11. The vehicle control device according to claim 10, wherein
the first braking force is set as a maximum braking force for holding the vehicle in a stopped state, and
the start controller gives, upon receipt of a start request, the command for applying the second braking force to the braking device to reduce a braking force.

12. The vehicle control device according to claim 11, wherein
the start controller acquires the gradient when a predetermined period of time elapses after the vehicle is stopped.

13. The vehicle control device according to claim 11, wherein
the start controller determines whether the braking force applied by the braking device has reached the second braking force, and outputs, when the braking force applied by the braking device has reached the second braking force, a command for making the braking force equal to zero to the braking device.

14. The vehicle control device according to claim 11, wherein
the stop hold module gives, to a driving device connected to the vehicle control device, a command for applying a first driving force which is preset, and
the start controller computes a second driving force which is equal to or greater than the first driving force and is proportional to the gradient of the road surface, and gives, upon receipt of the start request, a command for applying the second driving force to the driving device.

15. The vehicle control device according to claim 14, wherein
the start controller givens, upon receipt of the start request, a command for increasing a driving force from the first driving force to the second driving force to the driving device to increase the driving force.

16. The vehicle control device according to claim 15, wherein
the first driving force is a predetermined driving force generated when the vehicle is held in the stopped state, and
the second driving force is a driving force that is in balance with gradient resistance proportional to the gradient.

17. The vehicle control device according to claim 15, wherein
the start controller outputs, after the driving force has reached the second driving force, a command for reducing the braking force to the braking device.

18. The vehicle control device according to claim 11, wherein
the start controller computes gradient resistance proportional to the gradient, and computes the second braking force based on a driving force which a driving device connected to the vehicle control device is commanded to apply and the gradient resistance.
